(19) United States
(12) Patent Application Publication
(10) Pub. No.: US 2026/0257623 A1
(43) Pub. Date: Sep. 3, 2026

(54) DISPLAY REGION ADJUSTMENT METHOD AND DEVICE FOR ELECTRONIC REARVIEW MIRROR, STORAGE MEDIA, AND PRODUCT

(71) Applicant: FAURECIA (CHINA) HOLDING Co., Ltd., Shanghai (CN)

(72) Inventors: Wulong ZHANG, Shanghai (CN); Shengjie SUN, Shanghai (CN); Zhenxiang ZENG, Shanghai (CN); Chuyang HONG, Shanghai (CN); Chenyu XU, Shanghai (CN); Yilun YAN, Shanghai (CN)

(73) Assignee: FAURECIA (CHINA) HOLDING Co., Ltd., Shanghai (CN)

(21) Appl. No.: 19/532,056

(22) Filed: Feb. 6, 2026

(30) Foreign Application Priority Data
Feb. 28, 2025 (CN) 202510241335.0

(51) Int. Cl. B60R 1/28; G06T 7/73

(52) U.S. Cl. CPC B60R 1/28; G06T 7/73; B60R 2300/30; B60R 2300/602; G06T 2207/30252

(57) ABSTRACT

A display region adjustment method and device for an electronic rearview mirror, a storage medium, and a product are provided. The method includes: acquiring a rear view image displayed by an electronic rearview mirror, the rear view image being a portion of a raw image captured by a camera; determining first position information and second position information in response to the rear view image being detected to satisfy an adjustment condition, the adjustment condition being a condition for adjusting a display region, the first position information being position information of vehicle body feature points in the rear view image, the second position information being position information of vehicle body feature points in a preset standard rear view image; and adjusting the display region of the electronic rearview mirror based on the first position information and the second position information.

### CROSS-REFERENCE TO RELATED APPLICATION(S)

The present disclosure is filed based on Chinese Patent Application with the application No. 202510241335.0, filed on Feb. 28, 2025, and claims priority to the Chinese Patent Application, the entire content of the Chinese Patent Application is incorporated herein by reference.

### TECHNICAL FIELD

The present disclosure relates to the field of image processing technologies, and in particular, to a display region adjustment method and device for an electronic rearview mirror, a storage media, and a product.

### BACKGROUND

In recent years, with the rapid development of automotive intelligent technologies, electronic rearview mirrors have gradually become an important alternative to conventional optical rearview mirrors. The electronic rearview mirrors have significant advantages such as a wide field of view, low wind drag, and adaptability to complex weather scenarios. However, in a case where a vehicle frequently encounters scenarios such as bumpy roads, mechanical vibrations, or slight collisions during driving, the cameras may shift in position or angle, causing the images displayed by the electronic rearview mirrors to have a distorted field of view and a deviated viewing angle. This may cause the driver to misjudge the distance or position of rear vehicles, thereby posing safety hazards.

### SUMMARY

In a first aspect, a display region adjustment method for an electronic rearview mirror is provided in the present disclosure. The method includes: acquiring a rear view image displayed by an electronic rearview mirror, the rear view image being a portion of a raw image captured by a camera; determining first position information and second position information in response to the rear view image being detected to satisfy an adjustment condition, the adjustment condition being a condition for adjusting a display region, the first position information being position information of vehicle body feature points in the rear view image, the second position information being position information of vehicle body feature points in a standard rear view image; and adjusting the display region of the electronic rearview mirror based on the first position information and the second position information.

In an implementation, the adjusting the display region of the electronic rearview mirror based on the first position information and the second position information, includes: determining rotation parameters based on the first position information and the second position information, the rotation parameters being configured to reflect positional deviations between the vehicle body feature points in the rear view image and the vehicle body feature points in the standard rear view image; and adjusting the display region based on the rotation parameters.

In an implementation, the adjusting the display region based on the rotation parameters, includes: determining target cropping region parameters matching the rotation parameters based on a target mapping relationship, the target mapping relationship including cropping region parameters in one-to-one correspondence with a plurality of sets of rotation parameters and being determined based on measured data, the target cropping region parameters being configured to crop a target display region from the raw image; and controlling the electronic rearview mirror to display an image within the target display region.

In an implementation, the determining the rotation parameters based on the first position information and the second position information, includes: determining a homography matrix between the first position information and the second position information; determining a rotation matrix based on the homography matrix; and decomposing the rotation matrix to obtain the rotation parameters.

In an implementation, whether the rear view image satisfies the adjustment condition is detected by: determining first vehicle body contour information and second vehicle body contour information, the first vehicle body contour information being vehicle body contour information in the rear view image, the second vehicle body contour information being vehicle body contour information in the standard rear view image; and determining, based on the first vehicle body contour information and the second vehicle body contour information, whether the rear view image satisfies the adjustment condition.

In an implementation, the adjustment condition includes the following: an overlapping degree between first vehicle body contour information and second vehicle body contour information is greater than a first threshold and less than a second threshold.

In an implementation, the method further includes: outputting alarm information in response to the overlapping degree being less than the second threshold. The alarm information is configured to indicate that the electronic rearview mirror needs to be inspected and maintained.

In a second aspect, a display region adjustment device for an electronic rearview mirror is provided in the present disclosure. The display region adjustment device includes: an acquisition unit, a determination unit, and an adjustment unit. The acquisition unit is configured to acquire a rear view image displayed by an electronic rearview mirror. The rear view image is a portion of a raw image captured by a camera. The determination unit is configured to determine first position information and second position information in response to the rear view image being detected to satisfy an adjustment condition. The adjustment condition is a condition for adjusting a display region. The first position information is position information of vehicle body feature points in the rear view image. The second position information is position information of vehicle body feature points in a standard rear view image. The adjustment unit is configured to adjust the display region of the electronic rearview mirror based on the first position information and the second position information.

In an implementation, the adjustment unit is specifically configured to: determine rotation parameters based on the first position information and the second position information, the rotation parameters being configured to reflect positional deviations between the vehicle body feature points in the rear view image and the vehicle body feature points in the standard rear view image; and adjust the display region based on the rotation parameters.

In an implementation, the adjustment unit is specifically configured to: determine target cropping region parameters matching the rotation parameters based on a target mapping relationship, the target mapping relationship including cropping region parameters in one-to-one correspondence with a plurality of sets of rotation parameters and being determined based on measured data, the target cropping region parameters being configured to crop a target display region from the raw image; and control the electronic rearview mirror to display an image within the target display region.

In an implementation, the adjustment unit is specifically configured to: determine a homography matrix between the first position information and the second position information; determine a rotation matrix based on the homography matrix; and decompose the rotation matrix to obtain the rotation parameters.

In an implementation, the display region adjustment device further includes: a detection unit. The detection unit is specifically configured to: determine first vehicle body contour information and second vehicle body contour information, the first vehicle body contour information being vehicle body contour information in the rear view image, the second vehicle body contour information being vehicle body contour information in the standard rear view image; and determine, based on the first vehicle body contour information and the second vehicle body contour information, whether the rear view image satisfies the adjustment condition.

In an implementation, the adjustment condition includes the following: an overlapping degree between the first vehicle body contour information and the second vehicle body contour information is greater than a first threshold and less than a second threshold.

In an implementation, the device further includes an output unit. The output unit is configured to output alarm information in response to the overlapping degree being less than or equal to the first threshold. The alarm information is configured to indicate that the electronic rearview mirror needs to be inspected and maintained.

In a third aspect, a display region adjustment device for an electronic rearview mirror is provided in the present disclosure. The device includes: a processor and a communication interface. The communication interface is coupled to the processor. The processor is configured to run computer programs or instructions to perform the display region adjustment method for the electronic rearview mirror as described in the first aspect and any implementation of the first aspect.

In a fourth aspect, a non-transitory computer-readable storage medium storing instructions is provided in the present disclosure. Upon the instructions are run on a terminal, the terminal is enabled to perform the display region adjustment method for the electronic rearview mirror as described in the first aspect and any implementation of the first aspect.

In a fifth aspect, a computer program product including instructions is provided in the embodiments of the present disclosure. Upon the computer program product is run on a display region adjustment device for an electronic rearview mirror, the display region adjustment device for the electronic rearview mirror is enabled to perform the display region adjustment method for the electronic rearview mirror as described in the first aspect and any implementation of the first aspect.

In a sixth aspect, a chip is provided in the embodiments of the present disclosure. The chip includes a processor and a communication interface. The communication interface is coupled to the processor. The processor is configured to run computer programs or instructions to perform the display region adjustment method for the electronic rearview mirror as described in the first aspect and any implementation of the first aspect.

Specifically, the chip provided in the embodiments of the present disclosure further includes a memory for storing the computer programs or instructions.

In the present disclosure, a name of the display region adjustment device for the electronic rearview mirror does not constitute a limitation on the devices or functional modules themselves. In practical implementation, these devices or functional modules may be referred to by other names. Any device or functional module whose function is similar to that of the present disclosure falls within the scope of the claims of the present disclosure and equivalent technologies of the claims of the present disclosure.

### BRIEF DESCRIPTION OF THE DRAWINGS

FIG. 1 is a schematic diagram showing a structure of a vehicle provided in embodiments of the present disclosure;

FIG. 2 is a schematic diagram showing a hardware structure of a display region adjustment device provided in embodiments of the present disclosure;

FIG. 3 is a flow chart of a display region adjustment method for an electronic rearview mirror provided in embodiments of the present disclosure;

FIG. 4 is a schematic diagram of a training image provided in embodiments of the present disclosure;

FIG. 5 is a schematic diagram of a display region adjustment process provided in embodiments of the present disclosure;

FIG. 6 is a schematic diagram of a model training process provided in embodiments of the present disclosure;

FIG. 7 is a schematic diagram of a model inference process provided in embodiments of the present disclosure;

FIG. 8 is a schematic diagram of an image processing process provided in embodiments of the present disclosure;

FIG. 9 is a schematic diagram of a rotation parameter determination process provided in embodiments of the present disclosure;

FIG. 10 is a schematic diagram of another display region adjustment process provided in embodiments of the present disclosure; and

FIG. 11 is a schematic diagram showing a structure of a display region adjustment device provided in embodiments of the present disclosure.

### DETAILED DESCRIPTION

A display region adjustment method and device for an electronic rearview mirror provided in the embodiments of the present disclosure will be described in detail below with reference to the accompanying drawings.

Herein, the term “and/or” is merely an associated relationship for describing associated objects, which means that there may be three relationships. For example, A and/or B may mean: only A, A and B at the same time, and only B.

The terms “first” and “second” used in the specification and drawings of the present disclosure are used for distinguishing different objects or distinguishing different processing methods for the same object, rather than describing a specific order of objects.

In addition, the terms “comprise/comprising/include/including” and “have/has/having”, and any variations thereof, mentioned in the description of the present disclosure are intended to cover non-exclusive inclusion. For example, a process, method, system, product, or device that includes a series of steps or units is not limited to the listed steps or units, but may optionally include other unlisted steps or units, or may optionally include other steps or units inherent to these processes, methods, products, or devices.

It will be noted that, in the embodiments of the present disclosure, the term such as “exemplary” or “for example” is used to represent an example, illustration, or explanation. Any embodiment or design scheme described with “exemplary” or “for example” in the embodiments of the present disclosure is not necessarily to be construed as preferred or advantageous over other embodiments or design schemes. Rather, the use of the term such as “exemplary” or “for example” is intended to present relevant concepts in a specific manner.

First, some terms and related arts involved in the present disclosure will be explained and described to facilitate understanding by those skilled in the art.

Electronic rearview mirror: the electronic rearview mirror is an automotive technology that replaces conventional a glass rearview mirror with a camera and a display screen. The electronic rearview mirror helps a driver observe situations behind the vehicle and on a side of the vehicle by displaying images of the external environment of the vehicle in real time, and is one of the key directions in the development of automotive intelligence.

Raw image: the raw images are captured by cameras mounted on the sides and rear of the vehicle. These cameras generally have high resolution and wide-angle lenses, to ensure a sufficiently wide field of view is captured. The raw images may exhibit a certain degree of barrel distortion due to the use of the wide-angle lenses. This distortion needs to be corrected during image processing, to ensure that the image displayed to the driver is accurate.

Rear view image: the rear view image is obtained by performing image processing on the raw image. To adapt the rear view image to a size and aspect ratio of the display screen, the raw image may be cropped, meaning an image displayed on the display screen may be a portion of the raw image.

A brief introduction to the terms involved in the embodiments of the present disclosure is given above, and details will not be repeated below.

To facilitate understanding of the technical content of this solution, a specific process for displaying images on the electronic rearview mirror will be introduced below.

Image capture: an electronic rearview mirror system may capture raw images of the surrounding environment by using cameras mounted on the sides and rear of the vehicle.

Image transmission: the electronic rearview mirror system may transmit the captured raw images to an image processing unit inside the vehicle through data cables or wireless means.

In some embodiments, image data may be subjected to preliminary compression during transmission, so as to reduce data volume and improve transmission efficiency.

Image processing: the image processing unit may perform a series of processes on the received raw image, so as to obtain a rear view image.

In some embodiments, the image processing may include steps such as denoising, distortion (e.g., barrel distortion) correction, contrast enhancement, color correction, and cropping.

In addition, for nighttime or low-light environments, the image processing unit may also apply infrared fill light technologies or night vision enhancement technologies, to improve the light-sensitive performance and image clarity of the cameras.

Image display: the image processing unit may send the processed rear view image to a high-definition display screen inside the vehicle.

The display screen is generally located between a dashboard and a door of the vehicle, and has a touch function, which enables the driver to adjust the image display, switch functions, and perform other related operations.

In an implementation, the electronic rearview mirror system may have a function of automatically adjusting the image brightness, so as to adapt to different lighting conditions.

For example, when detecting high beams from a rear vehicle, the electronic rearview mirror system may automatically reduce the image brightness to avoid glare.

However, in a case where a vehicle frequently encounters scenarios such as bumpy roads, mechanical vibrations, or slight collisions during driving, the cameras may shift in position or angle, causing the captured images to have a distorted field of view, a deviated viewing angle, or a distorted image aspect ratio. For example, after the cameras are rotated or shifted, the originally preset image stitching, wide-angle correction algorithms, and cropping region will not be able to be accurately adapted. This may cause the driver to misjudge the distance or position of rear vehicles, thereby posing safety hazards.

Current solutions for camera displacement mainly depend on manual intervention. In a case where an abnormal field of view is detected, the vehicle needs to be transported to a professional maintenance shop, where technicians will use dedicated equipment to calibrate a physical position of the camera and recalibrate intrinsic parameters and extrinsic parameters (e.g., a focal length, optical center coordinates, distortion coefficients) of the camera. However, this process has the following significant drawbacks:
(1). manual calibration is inefficient and users have to incur additional time and financial money;
(2). the calibration accuracy is highly dependent on the experience level of the operator, which easily leads to human errors; and
(3). adaptability to dynamic scenarios is insufficient and the small displacements that frequently occur during vehicle operation cannot be responded to in real time.

In addition, existing electronic rearview mirror systems lack self-checking and adaptive compensation mechanisms for camera status, making it difficult to fundamentally solve long-term reliability problems caused by hardware displacement.

For the technical drawbacks, a display region adjustment method for an electronic rearview mirror provided in the present disclosure may acquire a rear view image displayed by an electronic rearview mirror, and in response to the rear view image being detected to satisfy a condition for adjusting a display region, determine first position information characterizing position information of vehicle body feature points in the rear view image and second position information characterizing position information of vehicle body feature points in a preset standard rear view image, and further adjust the display region of the electronic rearview mirror based on the first position information and the second position information.

On this basis, the present disclosure may monitor in real time whether the display region of the electronic rearview mirror deviates from the standard rear view image in the driving process of the vehicle, and in response to the occurrence of the deviation, adjust the region of the raw image displayed by the electronic rearview mirror based on the position information of the vehicle body feature points in the rear view image and the position information of the vehicle body feature points in the standard rear view image. This avoids the problems of large errors and the inability to adjust in real time caused by manual adjustment, ensuring that the display region of the electronic rearview mirror is always kept in an optimal state and improving driving safety.

The technical solutions in the embodiments of the present disclosure will be described below with reference to the accompanying drawings in the embodiments of the present disclosure. However, the described embodiments are merely some but not all of the embodiments of the present disclosure.

The display region adjustment method for the electronic rearview mirror provided in the embodiments of the present disclosure may be applied to a display region adjustment system of a vehicle. The vehicle may also be referred to as a means of transportation, a mobile carrier, an electric vehicle (EV), a hybrid electric vehicle (HEV), a plug-in hybrid electric vehicle (PHEV), a fuel cell vehicle (FCV), an autonomous vehicle, an intelligent and connected vehicle (ICVs), a driverless vehicles, etc.

In the embodiments of the present disclosure, the vehicle may be a sedan, a sport utility vehicle (SUV), a truck, an electromobile, a motorcycle, a tricycle, a special vehicle (e.g., an ambulance, a fire engine, a police vehicle), a driverless taxi, an intelligent and connected bus, an autonomous logistics vehicle, an electric freight vehicle, etc. In addition, this method is also applicable to a variety of special-purpose vehicles, such as agricultural vehicles, mining vehicles, forestry vehicles, airport vehicles, and port vehicles, and the present disclosure is not specifically limited thereto.

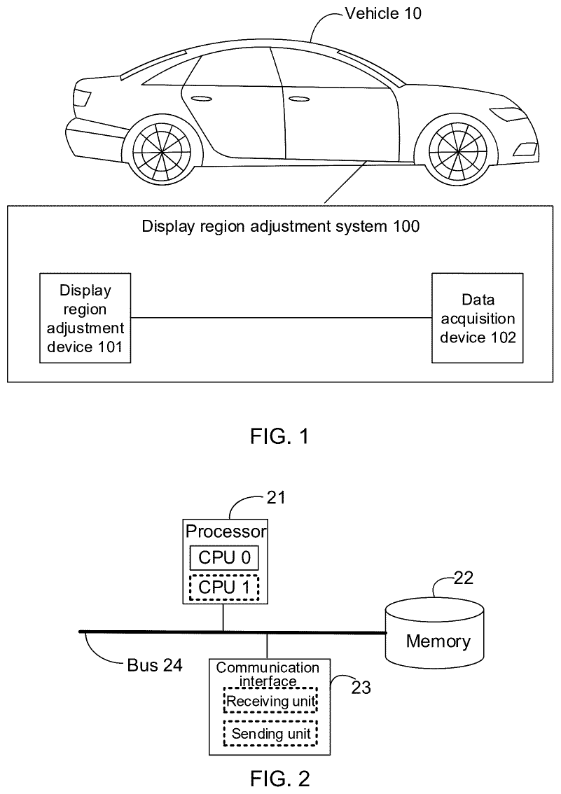

For example, as shown in FIG. 1, FIG. 1 is a schematic diagram showing a structure of a vehicle 10 provided in the embodiments of the present disclosure. The vehicle 10 may include a display region adjustment system 100. The display region adjustment system 100 may include a display region adjustment device 101 and a data acquisition device 102. A communication connection may be established between the display region adjustment device 101 and the data acquisition device 102.

In practical applications, the display region adjustment device 101 may be communicatively connected to one or more data acquisition devices 102.

For ease of understanding, the present disclosure is described by considering an example in which a display region adjustment device 101 is communicatively connected to a data acquisition device 102.

In some embodiments, the display region adjustment device 101 and the data acquisition device 102 in FIG. 1 may be functional modules integrated into the same device, or they may be two mutually independent devices, and the present disclosure is not limited thereto.

It is easy to understand that in a case where the display region adjustment device 101 and the data acquisition device 102 are functional modules integrated into the same device, a communication mode between the display region adjustment device 101 and the data acquisition device 102 is communication between internal modules of the device. In this case, a communication process between the display region adjustment device 101 and the data acquisition device 102 is the same as that in a case where the display region adjustment device 101 and the data acquisition device 102 are disposed independently of each other.

For ease of understanding, the present disclosure will be described by considering an example in which the display region adjustment device 101 and the data acquisition device 102 are disposed independently of each other.

The display region adjustment device 101 in FIG. 1 may be preconfigured with a standard rear view image. The data acquisition device 102 may acquire a rear view image displayed by an electronic rearview mirror and send the acquired rear view image to the display region adjustment device 101. The display region adjustment device 101 may determine, in response to detecting that the rear view image satisfies an adjustment condition, first position information characterizing position information of vehicle body feature points in the rear view image and second position information characterizing position information of vehicle body feature points in the preset standard rear view image, so as to further adjust a display region of the electronic rearview mirror based on the first position information and the second position information.

In some embodiments, the display region adjustment device 101 and data acquisition device 102 in FIG. 1 may be terminals, servers, or other types of electronic devices. FIG. 1 illustrates merely an example of the device form of the display region adjustment device 101 and the data acquisition device 102, and does not constitute any limitation thereto.

In a case where the display region adjustment device 101 and the data acquisition device 102 are terminals, the terminals may be a device that provides voice and/or data connectivity for a targeted user, a handheld device with a wireless connection function, or other processing devices connected to a wireless modem. The terminals may communicate with one or more core networks through a radio access network (RAN). The terminals may be a mobile terminal, such as a computer with a mobile terminal; alternatively, the terminals may be a portable mobile device, a pocket-sized mobile device, a handheld mobile device, or a computer-built-in mobile device that exchanges voice and/or data with the radio access network, such as a mobile phone, a tablet computer, a notebook computer, a netbook, or a personal digital assistant (PDA), and the present disclosure is not limited thereto.

In a case where the display region adjustment device 101 and the data acquisition device 102 are servers, the servers may be a single server or a server cluster consisting of a plurality of servers. In some implementations, the server cluster may also be a distributed cluster, and the present disclosure is not limited thereto.

As shown in FIG. 2, FIG. 2 is a schematic diagram showing a hardware structure of a display region adjustment device provided in the embodiments of the present disclosure. The display region adjustment device includes a processor 21, a memory 22, a communication interface 23, and a bus 24. The processor 21, memory 22 and communication interface 23 may be connected with each other through the bus 24.

The processor 21 serves as a control center of the display region adjustment device. The processor 21 may be a single processor or a collective designation for a plurality of processing elements. For example, the processor 21 may be a general-purpose central processing unit (CPU) or other general-purpose processors. The general-purpose processor may be a microprocessor or any conventional processor.

In an embodiment, the processor 21 may include one or more CPUs, such as the CPU 0 and the CPU 1 shown in FIG. 2.

The memory 22 may be, but is not limited to, a read-only memory (ROM) or other types of static storage devices capable of storing static information and instructions, a random access memory (RAM) or other types of dynamic storage devices capable of storing information and instructions, or an electrically erasable programmable read-only memory (EEPROM), a magnetic disk storage medium or any other magnetic storage device, or any other medium capable of being used to carry or store desired program codes and capable of being accessed by a computer, where the desired program codes have instructions or are in the form of data structure.

In an implementation, the memory 22 may exist independently of the processor 21. The memory 22 may be connected to the processor 21 through the bus 24 and used for storing instructions or program codes. When calling and executing the instructions or program codes stored in the memory 22, the processor 21 may perform the display region adjustment method for the electronic rearview mirror provided in the following embodiments of the present disclosure.

In another implementation, the memory 22 may also be integrated with the processor 21.

The communication interface 23 is used for connecting the display region adjustment device to other devices through a communication network. The communication network may be an Ethernet, a radio access network, a wireless local area network (WLAN), or the like. The communication interface 23 may include a receiving unit for receiving data and a sending unit for sending data.

The bus 24 may be an industry standard architecture (ISA) bus, a peripheral component interconnect (PCI) bus, or an extended industry standard architecture (EISA) bus, etc. The bus may be classified as an address bus, a data bus, and a control bus. For ease of representation, only one bold line is used in FIG. 2, but it does not mean that there is only one bus or one type of bus.

It will be noted that the structure shown in FIG. 2 does not constitute any limitation on the display region adjustment device. In addition to the components shown in FIG. 2, the display region adjustment device may include more or fewer components than those illustrated, or combine certain components, or adopt different component arrangements.

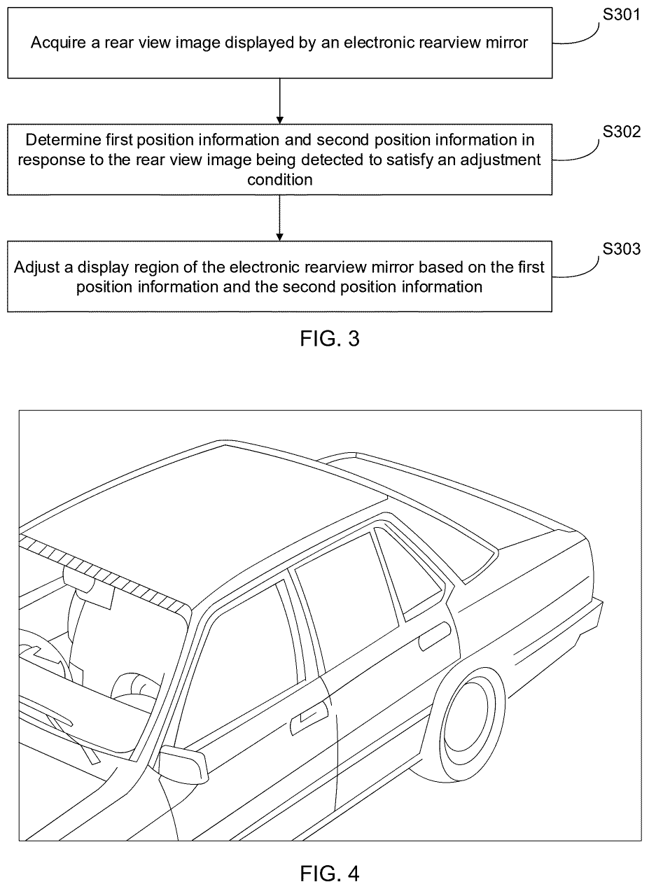

As shown in FIG. 3, FIG. 3 is a flow chart of a display region adjustment method for an electronic rearview mirror provided in the embodiments of the present disclosure. The display region adjustment method for the electronic rearview mirror may be applied to the display region adjustment device 101 of the display region adjustment system 100 shown in FIG. 1. The display region adjustment method for the electronic rearview mirror includes S301 to S303.

In S301, a rear view image displayed by an electronic rearview mirror is acquired.

The rear view image is a portion of a raw image captured by a camera.

In an implementation, after the vehicle is started, the camera deployed on the vehicle starts to operate, continuously captures raw images of a region behind the vehicle, and transmits these images to the display region adjustment device in real time. The display region adjustment device may crop the raw image based on cropping region parameters at the current moment, so as to obtain the rear view image displayed by the electronic rearview mirror.

In S302, in response to the rear view image being detected to satisfy an adjustment condition, first position information and second position information are determined.

The adjustment condition may be a condition for adjusting a display region, the first position information may be position information of vehicle body feature points in the rear view image, and the second position information may be position information of vehicle body feature points in the pre-set standard rear view image.

In an example, the vehicle body feature points may include a plurality of feature points such as window frame points, door handle position points, and side edge points, and the present disclosure is not specifically limited thereto.

In an implementation, after acquiring the rear view image, the display region adjustment device may determine first vehicle body contour information and second vehicle body contour information. The display region adjustment device may determine whether the rear view image satisfies the adjustment condition based on the first vehicle body contour information and the second vehicle body contour information. For the specific implementation for the display region adjustment device to detect the rear view image to determine whether the rear view image satisfies the adjustment condition, reference may be made to the following S401 and S402, and details will not be repeated herein.

In an implementation, the display region adjustment device may be configured with a position recognition model. In response to detecting that the rear view image satisfies the adjustment condition, the display region adjustment device may input the rear view image and the standard rear view image into the position recognition model. The position recognition model may identify positions of vehicle body feature points in the rear view image and the standard rear view image, and determine the first position information and the second position information.

Alternatively, the display region adjustment device may be preconfigured with the second position information. In response to detecting that the rear view image satisfies the adjustment condition, the display region adjustment device may input the rear view image into the position recognition model. The position recognition model may identify positions of vehicle body feature points in the rear view image and determine the first position information.

In an implementation, the position recognition model is obtained through training.

For example, the display region adjustment device may acquire a training dataset, that is, acquire a plurality of training images through the electronic rearview mirror.

The training images may include images corresponding to different angles, different lighting conditions, and different vehicle types, so as to ensure the generalization capability of the model.

For example, as shown in FIG. 4, FIG. 4 is a schematic diagram of a training image.

The display region adjustment device or developers may annotate each training image to obtain a training dataset with annotation information. The annotation information may include vehicle body feature points. The annotation information may be in the form of coordinates, which characterizes the positions of the feature points in the image.

The display region adjustment device may normalize the training dataset to ensure that all inputs have the same resolution and size. Moreover, the display region adjustment device may perform data augmentation on the training dataset, such as rotation, scaling, and flipping, to increase data diversity and improve the robustness of the model.

The display region adjustment device may select a suitable deep learning model architecture according to task requirements. For example, the display region adjustment device may construct an end-to-end initial position recognition model by means of a convolutional neural network.

The display region adjustment device may train the initial position recognition model by using the training dataset, and select a suitable loss function and gradient descent method to measure a difference between the predicted position and the actual position, so as to optimize the model parameters, thereby obtaining the position recognition model.

In S303, the display region of the electronic rearview mirror is adjusted based on the first position information and the second position information.

The display region may be used to characterize a partial region of the raw image.

In an implementation, the display region adjustment device may determine rotation parameters based on the first position information and the second position information. The display region adjustment device may determine positional deviations between the vehicle body feature points in the rear view image and the vehicle body feature points in the standard rear view image based on the rotation parameters.

In an example, the rotation parameters may include three angle parameters representing the rotational attitude in three-dimensional space, namely a yaw angle, a pitch angle, and a roll angle.

In an implementation, in order to determine the rotation parameters based on the first position information and the second position information, the display region adjustment device may determine a homography matrix between the first position information and the second position information.

For example, the homography matrix has a form that satisfies the following first formula:

$$H = [ \begin{matrix}{h}_{00} & {h}_{01} & {h}_{02} \\ {h}_{10} & {h}_{11} & {h}_{12} \\ {h}_{20} & {h}_{21} & {h}_{22}\end{matrix} ] . \qquad first formula$$

Herein, h₀₀ and h₁₁ may be used to control scaling; h₀₁ and h₁₀ may be used to control shearing and rotation; h₀₂ may be used to control horizontal translation; h₁₂ may be used to control vertical translation; h₂₀ and h₂₁ may be used to control the perspective distortion of an image; h₂₂ may be used to represent a normalization factor of homogeneous coordinates. The homography matrix may be used to characterize a perspective transformation relationship between the rear view image and the standard rear view image.

The display region adjustment device may determine a rotation matrix of a camera by performing singular value decomposition (SVD) on the homography matrix based on an intrinsic parameter matrix of the camera.

For example, the homography matrix, the rotation matrix, and the intrinsic parameter matrix of the camera satisfy the following second formula:

$$H = K \cdot [ R \vert t ] \cdot {K}^{- 1} . \qquad second formula$$

Herein, H may be used to characterize the homography matrix; R may be used to characterize the rotation matrix; K may be used to characterize the intrinsic parameter matrix of the camera; and t may be used to characterize a translation vector.

The display region adjustment device may calculate an orthonormal matrix based on the second formula. The orthonormal matrix satisfies the following third formula:

$${H}^{′} = {K}^{- 1} \cdot H \cdot {K}^{- T} . \qquad third formula$$

Herein, H′ may be used to characterize the orthonormal matrix. K^{-T} may be used to characterize a transpose matrix of K⁻¹.

The display region adjustment device may perform the SVD on the orthonormal matrix, and the SVD satisfies the following fourth formula:

$${H}^{′} = {U}^{′} \cdot {Σ}^{′} \cdot {V}^{′} . \qquad fourth formula$$

Herein, U′ and V′ may be used to represent an orthogonal matrix; a column of U′ is an eigenvector of a product of H′ and H′^{T} (i.e., H′H′^{T}); a column of V′ is an eigenvector of a product of H′^{T} and H′ (i.e., H′^{T}H′); Σ′ may be used to characterize a diagonal matrix, and elements on a diagonal of the diagonal matrix are referred to as singular values.

The display region adjustment device may determine the rotation matrix based on U′ and V^{T} in the fourth formula. The rotation matrix satisfies the following fifth formula, and the rotation matrix has a form that satisfies the following sixth formula:

$$R = {U}^{′} \cdot {V}^{T} ; \qquad fifth formula$$

$$R = [ \begin{matrix}{R}_{00} & {R}_{01} & {R}_{02} \\ {R}_{10} & {R}_{11} & {R}_{12} \\ {R}_{20} & {R}_{21} & {R}_{22}\end{matrix} ] . \qquad sixth formula$$

Herein, R may be used to characterize the rotation matrix; R₀₀, R₁₁, and R₂₂ may be used to characterize scaling factors of coordinate axes; R₀₁, R₁₀, R₀₂, R₂₀, R₁₂, and R₂₁ may be used to characterize the cross-interactions of the coordinate axes; and V^{T} may be used to characterize a transpose matrix of V″.

The display region adjustment device may decompose the rotation matrix to obtain the rotation parameters.

For example, the rotation parameters satisfy the following seventh formula with reference to the sixth formula:

$$\{ \begin{matrix}Yaw = arctan 2 ( {R}_{10} , {R}_{00} ) \\ Pitch = arctan 2 ( - R 20 , {( {R}_{00} \cdot {R}_{00} + {R}_{10} \cdot {R}_{10} )}^{2} ) \\ Roll = arctan 2 ( {R}_{21} , {R}_{22} )\end{matrix} . \qquad seventh formula$$

Herein, the Yaw may be used to characterize the yaw angle. The Pitch may be used to characterize the pitch angle. The Roll may be used to characterize the roll angle. R₀₀, R₁₁, and R₂₂ may be used to characterize scaling factors of coordinate axes, R₀₁, R₁₀, R₀₂, R₂₀, R₁₂, and R₂₁ may be used to characterize the cross-interactions of the coordinate axes.

In an implementation, in order to adjust the display region based on the rotation parameters, the display region adjustment device may determine target cropping region parameters matching the rotation parameters based on a target mapping relationship, so as to further control the electronic rearview mirror to display an image within a target display region. For the specific implementation for the display region adjustment device to adjust the display region based on the rotation parameters, reference may be made to the following S501 and S502, and details will not be repeated herein.

Based on the technical solutions described above, the present disclosure may monitor in real time whether the display region of the electronic rearview mirror deviates from the standard rear view image in the driving process of the vehicle, and in response to the occurrence of the deviation, adjust the region of the raw image displayed by the electronic rearview mirror based on the position information of the vehicle body feature points in the rear view image and the position information of the vehicle body feature points in the standard rear view image. This avoids the problems of large errors and the inability to adjust in real time caused by manual adjustment, ensuring that the display region of the electronic rearview mirror is always kept in an optimal state and improving driving safety.

In some embodiments, in order to detect whether the rear view image satisfies the adjustment condition, the display region adjustment method for the electronic rearview mirror provided in the present disclosure further includes the following steps S401 and S402.

In S401, first vehicle body contour information and second vehicle body contour information are determined.

The first vehicle body contour information may be vehicle body contour information in the rear view image. The second vehicle body contour information may be vehicle body contour information in the standard rear view image.

It may be understood that, the standard rear view image may be a preset reference image in the display region adjustment device, representing an ideal field of view. The standard rear view image may be determined based on vehicle design parameters, road safety regulations, and field of view requirements of drivers, and is used to ensure that drivers may have a clear and accurate rear view complying with safety standards during driving.

In an implementation, the display region adjustment device may be preconfigured with the vehicle body contour information in the standard rear view image.

In another implementation, the display region adjustment device may be deployed with a vehicle body contour segmentation model. The display region adjustment device may input the rear view image into the vehicle body contour segmentation model. The vehicle body contour segmentation model may extract a vehicle body rectangular box from the rear view image. The vehicle body contour segmentation model may remove the environmental background within the vehicle body rectangular box, so as to obtain a vehicle body image. The vehicle body contour segmentation model may perform pixel-level segmentation on the vehicle body based on a segmentation algorithm, so as to extract the first vehicle body contour information.

It will be noted that the training process of the vehicle body contour segmentation model is similar to that of the position recognition model in the S302, and the model training process will not be repeated in detail herein.

In S402, it is determined whether the rear view image satisfies the adjustment condition based on the first vehicle body contour information and the second vehicle body contour information.

In an example, the adjustment condition may include the following: an overlapping degree between the first vehicle body contour information and the second vehicle body contour information is greater than a first threshold and less than a second threshold.

In some embodiments, the first threshold may be set according to actual requirements. For example, the first threshold may be equal to 65% or 70%, and the present disclosure is not specifically limited thereto.

In some embodiments, the second threshold may be set according to actual requirements. For example, the second threshold may be equal to 95% or 90%, and the present disclosure is not specifically limited thereto.

In an implementation, the display region adjustment device may be deployed with an overlapping degree determination model. The display region adjustment device may input the first vehicle body contour information and the second vehicle body contour information into the overlapping degree determination model. The overlapping degree determination model may identify the overlapping degree between the first vehicle body contour information and the second vehicle body contour information, and determine the overlapping degree between the first vehicle body contour information and the second vehicle body contour information.

It will be noted that the training process of the overlapping degree determination model is similar to that of the position recognition model in the S302, and the model training process will not be repeated in detail herein.

In another implementation, in response to the overlapping degree being less than or equal to the first threshold, the display region adjustment device may output alarm information.

The alarm information is used to indicate that the electronic rearview mirror needs to be inspected and maintained, meaning that the electronic rearview mirror has the excessive deviation and requires professional equipment for inspection and correction.

On this basis, the present disclosure may accurately capture subtle changes in the shape and size of the vehicle body in the real-time rear view image by comparing the vehicle body contour information (i.e., the first vehicle body contour information) in the rear view image with the vehicle body contour information (i.e., the second vehicle body contour information) in the standard rear view image, and determine whether the rear view image needs to be adjusted based on such changes, thereby ensuring the reliability of determination for the adjustment condition.

In some embodiments, in order to adjust the display region based on the rotation parameters, the display region adjustment method for the electronic rearview mirror provided in the present disclosure further includes the following S501 and S502.

In S501, the target cropping region parameters matching the rotation parameters are determined based on the target mapping relationship.

The target mapping relationship may include: cropping region parameters in one-to-one correspondence with a plurality of sets of rotation parameters. The target mapping relationship may be determined based on measured data. The target cropping region parameters may be used to crop the target display region from the raw image.

It will be noted that the target cropping region parameters may include two coordinate points. The target display region may be a rectangular region determined from the raw image based on the target cropping region parameters.

For example, as shown in Table 1, Table 1 shows some target mapping relationships.

TABLE 1

| | | | Upper left | Lower right |
|---|---|---|---|---|
| Pitch | Yaw | Roll | corner (x, y) | corner (x, y) |
| −2 | 0 | 2 | (x1, y1) | (x8, y2) |
| −2 | 2 | −2 | (x2, y1) | (x9, y2) |
| −2 | 2 | 0 | (x3, y1) | (x10, y2) |
| −2 | 2 | 2 | (x4, y1) | (x11, y2) |
| 0 | −2 | −2 | (x5, y1) | (x12, y2) |
| 0 | −2 | 0 | (x6, y1) | (x13, y2) |
| 0 | −2 | 2 | (x7, y1) | (x14, y2) |

The display region adjustment device may determine the target cropping region parameters matching the rotation parameters based on the target mapping relationship.

For example, referring to Table 1, if the rotation parameters are (−2, 2, −2), the display region adjustment device may determine the target cropping region parameters as (x2, y1) and (x9, y2) based on the target mapping relationship.

In S502, the electronic rearview mirror is controlled to display the image within the target display region.

In an implementation, after determining the target display region, the display region adjustment device may transmit the target display region to the display screen of the electronic rearview mirror for the driver to view.

On this basis, the present disclosure may quickly and accurately determine, through the pre-established target mapping relationship, the suitable cropping region parameters based on the rotation parameters, so as to further adjust the display region of the electronic rearview mirror and enable the driver to obtain an optimal field of view.

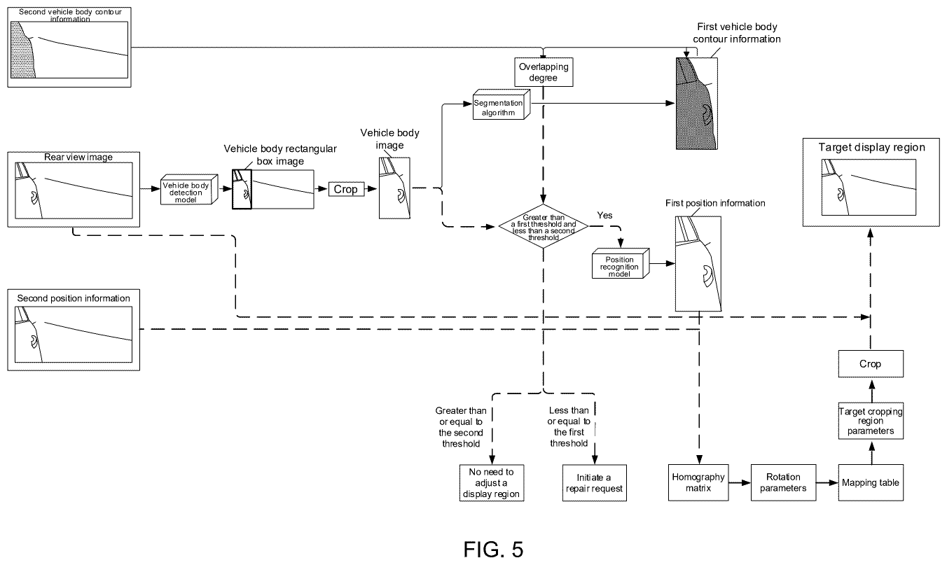

In some embodiments, as shown in FIG. 5, FIG. 5 is a schematic diagram of a display region adjustment process.

In an implementation, the solid line in FIG. 5 represents a process in the display region adjustment process for determining whether the electronic rearview mirror is deflected, while the dashed line represents a process in the display region adjustment process for performing the adjustment.

In an implementation, the process for determining whether the electronic rearview mirror is deflected includes the following: the display region adjustment device may input the rear view image into a vehicle body detection model, to obtain a vehicle body rectangular box image; the display region adjustment device may crop the vehicle body rectangular box image, to obtain a vehicle body image; and the display region adjustment device may segment the vehicle body image based on the segmentation algorithm, to obtain the first vehicle body contour information.

In an implementation, the process for performing the adjustment includes the following: the display region adjustment device may determine an overlapping degree between the first vehicle body contour information and the second vehicle body contour information; the display region adjustment device may, in response to the overlapping degree being greater than the first threshold and less than the second threshold, input the rear view image into the position recognition model, to obtain the first position information; the display region adjustment device may determine the homography matrix between the first position information and the second position information; the display region adjustment device may determine the rotation parameters based on the homography matrix; the display region adjustment device may determine the target cropping region parameters matching the rotation parameters based on a target mapping table (e.g., the Table 1); and the display region adjustment device may crop the raw image based on the target cropping region parameters, to obtain the target display region.

In an implementation, if the overlapping degree is less than or equal to the first threshold, the display region adjustment device may initiate a repair request. If the overlapping degree is greater than or equal to the second threshold, the display region adjustment device does not need to adjust the display region.

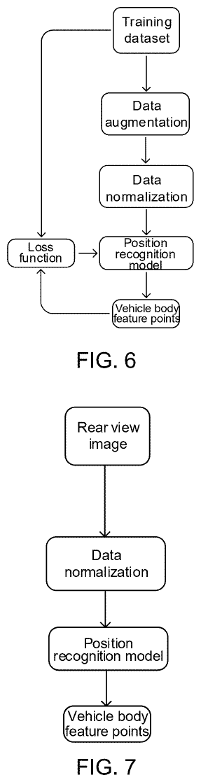

In an example, as shown in FIG. 6, FIG. 6 is a schematic diagram of a model training process provided in the present disclosure.

In an implementation, the display region adjustment device acquires a training dataset. The display region adjustment device may perform data augmentation and data normalization on the training dataset. The display region adjustment device optimizes a model based on the training dataset, a loss function, and vehicle body feature points, so as to obtain a position recognition model. The display region adjustment device may determine vehicle body feature points based on the position recognition model.

In an example, as shown in FIG. 7, FIG. 7 is a schematic diagram of a model inference process provided in the present disclosure.

In an implementation, the display region adjustment device may acquire a rear view image. The display region adjustment device may perform data normalization on the rear view image. The display region adjustment device may input the normalized rear view image into the position recognition model. The position recognition model may identify the normalized rear view image to determine the vehicle body feature points.

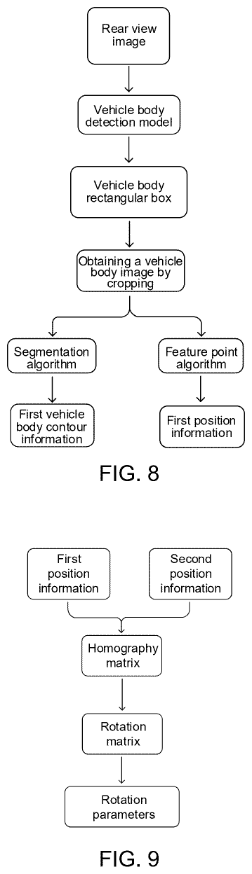

In an example, as shown in FIG. 8, FIG. 8 is a schematic diagram of an image processing process provided in the present disclosure.

In an implementation, the display region adjustment device may input a rear view image into a vehicle body detection model. The vehicle body detection model may determine a vehicle body rectangular box. The display region adjustment device may obtain a vehicle body image by cropping based on the vehicle body rectangular box. The display region adjustment device may determine the first vehicle body contour information based on the segmentation algorithm. The display region adjustment device may determine the first position information based on a feature point algorithm.

In an example, as shown in FIG. 9, FIG. 9 is a schematic diagram of a rotation parameter determination process provided in the present disclosure.

In an implementation, the display region adjustment device may acquire the first position information and the second position information. The display region adjustment device may determine a homography matrix between first position information and second position information. The display region adjustment device may determine a rotation matrix based on the homography matrix. The display region adjustment device may decompose the rotation matrix to obtain rotation parameters.

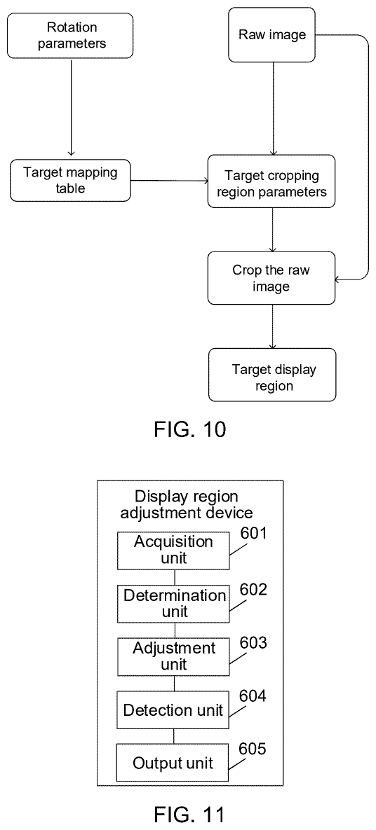

In an example, as shown in FIG. 10, FIG. 10 is a schematic diagram of a display region adjustment process provided in the present disclosure.

In an implementation, the display region adjustment device may determine target cropping region parameters based on rotation parameters and a target mapping table. The display region adjustment device may crop the raw image based on the target cropping region parameters, to obtain a target display region.

In an example, as shown in FIG. 11, FIG. 11 is a schematic diagram showing a structure of a display region adjustment device provided in the embodiments of the present disclosure. The display region adjustment device is used to perform the display region adjustment method for the electronic rearview mirror provided in the present disclosure, such as the display region adjustment method for the electronic rearview mirror in FIG. 3. The display region adjustment device may include: an acquisition unit 601, a determination unit 602, an adjustment unit 603, a detection unit 604, and an output unit 605.

In an implementation, the acquisition unit 601 is configured to acquire a rear view image displayed by an electronic rearview mirror.

In an implementation, the determination unit 602 is configured to determine first position information and second position information in response to the rear view image being detected to satisfy an adjustment condition.

In an implementation, the adjustment unit 603 is configured to adjust a display region of the electronic rearview mirror based on the first position information and the second position information.

In an implementation, the adjustment unit 603 is specifically configured to: determine rotation parameters based on the first position information and the second position information; and adjust the display region based on the rotation parameters.

In an implementation, the adjustment unit 603 is specifically configured to: determine target cropping region parameters matching the rotation parameters based on a target mapping relationship; and control the electronic rearview mirror to display an image within a target display region.

In an implementation, the adjustment unit 603 is specifically configured to: determine a homography matrix between the first position information and the second position information; determine a rotation matrix based on the homography matrix; and decompose the rotation matrix to obtain the rotation parameters.

In an implementation, the detection unit 604 is specifically configured to: determine first vehicle body contour information and second vehicle body contour information; and determine, based on the first vehicle body contour information and the second vehicle body contour information, whether the rear view image satisfies the adjustment condition.

In an implementation, the adjustment condition includes the following: an overlapping degree between the first vehicle body contour information and the second vehicle body contour information is greater than a first threshold and less than a second threshold.

In an implementation, the output unit 605 is configured to output alarm information in response to an overlapping degree being less than or equal to the first threshold.

In addition, for the technical effects of the display region adjustment device in FIG. 11, reference may be made to the technical effects of the display region adjustment method for the electronic rearview mirror in the embodiments described above, and details will not be repeated herein.

Through the description of the implementations described above, those skilled in the art may clearly understand that, for the convenience and brevity of the description, the division of the functional modules described above is used as only an example. In practical applications, the functions described above may be allocated to be completed by different functional modules as required, that is, the internal structure of the device may be divided into different functional modules, to complete all or some of the functions described above. For the specific operating process of the system, devices and units described above, reference may be made to the corresponding process in the method embodiments described above, and details will not be repeated herein.

A computer program product including instructions is provided in the embodiments of the present disclosure. Upon the computer program product is run on a computer, the computer is enabled to perform the display region adjustment method for the electronic rearview mirror in the method embodiments described above.

A computer-readable storage medium (e.g., a non-transitory computer-readable storage medium) storing instructions is also provided in the embodiments of the present disclosure. Upon the instructions are run on a computer, the computer is enabled to perform the display region adjustment method for the electronic rearview mirror in the method processes shown in the method embodiments described above.

The computer-readable storage medium may be, for example, but not limited to, an electrical, magnetic, optical, electromagnetic, infrared, or semiconductor system, apparatus, or device, or any combination thereof. More specific examples (a non-exhaustive list) of the computer-readable storage media include: an electrical connection having one or more wires, a portable computer disk, a hard disk, a random access memory (RAM), a read-only memory (ROM), an erasable programmable read-only memory (EPROM), a register, a hard disk, an optical fibers, a portable compact disc read-only memory (CD-ROM), an optical storage device, a magnetic storage device, any suitable combination of the examples described above, or any other form of computer-readable storage media known in the art. An exemplary storage medium is coupled to a processor, enabling the processor to read information from the storage medium and write information to the storage medium. Of course, the storage media may also be a component of the processor. The processor and storage media may be located in an application specific integrated circuit (ASIC). In the embodiments of the present disclosure, the computer-readable storage medium may be any tangible medium that contains or stores a program that can be used by, or in conjunction with, an instruction execution system, apparatus, or device.

Since the display region adjustment device, computer-readable storage medium, and computer program product in the embodiments of the present disclosure may be applied to the method described above, the technical effects achievable thereby may also be referred to the technical effects of the method embodiments described above, and details will not be repeated herein in the embodiments of the present disclosure.

The above are merely specific implementations of the present disclosure, but the protection scope of the present disclosure is not limited thereto, and any variations or replacements within the technical scope disclosed in the present disclosure shall fall within the protection scope of the present disclosure. Therefore, the protection scope of the present disclosure shall be subject to the protection scope of the claims.

What is claimed is:

1. A display region adjustment method for an electronic rearview mirror, comprising:
acquiring a rear view image displayed by an electronic rearview mirror; the rear view image being a portion of a raw image captured by a camera;
determining first position information and second position information in response to the rear view image being detected to satisfy an adjustment condition; the adjustment condition being a condition for adjusting a display region; the first position information being position information of vehicle body feature points in the rear view image; the second position information being position information of vehicle body feature points in a preset standard rear view image; and
adjusting the display region of the electronic rearview mirror based on the first position information and the second position information.

2. The method according to claim 1, wherein the adjusting the display region of the electronic rearview mirror based on the first position information and the second position information, comprises:
determining rotation parameters based on the first position information and the second position information; wherein the rotation parameters are configured to reflect positional deviations between the vehicle body feature points in the rear view image and the vehicle body feature points in the standard rear view image; and
adjusting the display region based on the rotation parameters.

3. The method according to claim 2, wherein the adjusting the display region based on the rotation parameters, comprises:
determining target cropping region parameters matching the rotation parameters based on a target mapping relationship; wherein the target mapping relationship includes cropping region parameters in one-to-one correspondence with a plurality of sets of rotation parameters and is determined based on measured data; the target cropping region parameters are configured to crop a target display region from the raw image; and
controlling the electronic rearview mirror to display an image within the target display region.

4. The method according to claim 2, wherein the determining the rotation parameters based on the first position information and the second position information, comprises:
determining a homography matrix between the first position information and the second position information;
determining a rotation matrix based on the homography matrix; and
decomposing the rotation matrix to obtain the rotation parameters.

5. The method according to claim 1, wherein whether the rear view image satisfies the adjustment condition is detected by:
determining first vehicle body contour information and second vehicle body contour information; wherein the first vehicle body contour information is vehicle body contour information in the rear view image; the second vehicle body contour information is vehicle body contour information in the standard rear view image; and
determining, based on the first vehicle body contour information and the second vehicle body contour information, whether the rear view image satisfies the adjustment condition.

6. The method according to claim 5, wherein the adjustment condition includes the following:
an overlapping degree between the first vehicle body contour information and the second vehicle body contour information is greater than a first threshold and less than a second threshold.

7. The method according to claim 6, further comprising:
outputting alarm information in response to the overlapping degree being less than or equal to the first threshold; wherein the alarm information is configured to indicate that the electronic rearview mirror needs to be inspected and maintained.

8. A display region adjustment device for an electronic rearview mirror, wherein the display region adjustment device comprises: an acquisition unit, a determination unit, and an adjustment unit;
the acquisition unit is configured to acquire a rear view image displayed by an electronic rearview mirror; the rear view image is a portion of a raw image captured by a camera;
the determination unit is configured to determine first position information and second position information in response to the rear view image being detected to satisfy an adjustment condition; the adjustment condition is a condition for adjusting a display region; the first position information is position information of vehicle body feature points in the rear view image; the second position information is position information of vehicle body feature points in a preset standard rear view image; and
the adjustment unit is configured to adjust the display region of the electronic rearview mirror based on the first position information and the second position information.

9. The device according to claim 8, wherein the adjustment unit is configured to:
determine rotation parameters based on the first position information and the second position information; wherein the rotation parameters are configured to reflect positional deviations between the vehicle body feature points in the rear view image and the vehicle body feature points in the standard rear view image; and
adjust the display region based on the rotation parameters.

10. The device according to claim 9, wherein the adjustment unit is configured to:
determine target cropping region parameters matching the rotation parameters based on a target mapping relationship; wherein the target mapping relationship includes cropping region parameters in one-to-one correspondence with a plurality of sets of rotation parameters and is determined based on measured data; the target cropping region parameters are configured to crop a target display region from the raw image; and
control the electronic rearview mirror to display an image within the target display region.

11. The device according to claim 9, wherein the adjustment unit is configured to:
determine a homography matrix between the first position information and the second position information;
determine a rotation matrix based on the homography matrix; and
decompose the rotation matrix to obtain the rotation parameters.

12. The device according to claim 8, further comprising a detection unit, wherein the detection unit is configured to:
determine first vehicle body contour information and second vehicle body contour information; wherein the first vehicle body contour information is vehicle body contour information in the rear view image; the second vehicle body contour information is vehicle body contour information in the standard rear view image; and
determine, based on the first vehicle body contour information and the second vehicle body contour information, whether the rear view image satisfies the adjustment condition.

13. The device according to claim 12, wherein the adjustment condition includes the following:
an overlapping degree between the first vehicle body contour information and the second vehicle body contour information is greater than a first threshold and less than a second threshold.

14. The device according to claim 13, further comprising an output unit, wherein the output unit is configured to:
output alarm information in response to the overlapping degree being less than or equal to the first threshold; wherein the alarm information is configured to indicate that the electronic rearview mirror needs to be inspected and maintained.

15. A non-transitory computer-readable storage medium, wherein the non-transitory computer-readable storage medium has stored instructions, upon the instructions are executed by a computer, the computer performs the method according to claim 1.

16. A computer program product comprising instructions, wherein upon the instructions are run on a computer, the computer is enabled to perform the method according to claim 1.
